(19) United States
(12) Patent Application Publication
(10) Pub. No.: US 2018/0298867 A1
(43) Pub. Date: Oct. 18, 2018

(54) DUAL BATTERY DEVICE

(71) Applicant: KUNG-JEN HUNG, TAIPEI CITY (TW)

(72) Inventor: KUNG-JEN HUNG, TAIPEI CITY (TW)

(21) Appl. No.: 15/490,721

(22) Filed: Apr. 18, 2017

(51) Int. Cl. F02N 11/08; H02J 7/14; F02N 11/04

(52) U.S. Cl. CPC F02N 11/0866; H02J 7/345; F02N 11/04; H02J 7/14

(57) ABSTRACT

A dual battery device is provided, which is a rechargeable battery. The dual battery device includes an energy battery and a power battery which are connected in parallel to supply the required electricity to a load by using the principle of an electric potential difference. The energy battery is a lithium structure, and the power battery is a capacitor. Thereby, the cost of the dual battery device without an expensive battery management system is reduced greatly. The size and weight of the dual battery device is about one-third of the prior art. The service life of the battery can be prolonged to improve the battery technology greatly.

### FIELD OF THE INVENTION

The present invention relates to a dual battery device, and more particularly to a rechargeable battery without an expensive battery management system.

### BACKGROUND OF THE INVENTION

Rechargeable batteries have been widely used in all kinds of daily life items, including a battery used to start the engine of a car or a motorcycle as an example. Most of the existing batteries for cars and motorcycles are lead-acid batteries. The service life of a lead-acid battery decreases due to increased resistance to shorten the period of use. Overcharge may produce dangerous combustible hydrogen. Besides, the lead-acid battery is heavy and large. There is a high risk of environmental pollution after the lead-acid is abandoned, so it is not ideal. In recent years, the industry developed a lithium battery. The size and weight of a lithium battery are about a half of a lead-acid battery, and the service life of a lithium battery is longer. However, because it will produce high discharging power, so the lithium battery must be equipped with an expensive battery management system for a normal operation, resulting in that the lithium battery is almost 3 to 4 times more expensive than the traditional lead-acid battery, so the consumer acceptance is not high and sales cannot increase. The voltage of the lithium battery is low, only about 3.3V, so there are severe limitations on the application. Accordingly, the inventor of the present invention has devoted himself based on his many years of practical experiences to solve these problems.

### SUMMARY OF THE INVENTION

In view of the shortcoming of the prior art, the primary object of the present invention is to provide a dual battery device. The size and weight of the dual battery device are about one-third of a lead-acid battery and smaller than a lithium battery. The cost is almost the same as that of a lead-acid battery. There is no need for an expensive battery management system, so the structure is relatively simple to lower the cost and the price. The probability of failure is reduced and the service life can be prolonged to improve the battery technology greatly.

In order to achieve the aforesaid object, the dual battery device of the present invention is composed of an energy battery and a power battery. Specifically, the dual battery device is a lithium carbon dual battery.

Preferably, the energy battery is a lithium structure for storing electric energy. The power battery is a capacitor for charging and discharging instantaneously. Preferably, the power battery is a capacitor. Thereby, the dual battery device doesn't need an expensive battery management system, that is, it can be directly used.

The main feature of the present invention is that the energy battery and the power battery are connected in parallel to supply the required electricity to a load by using the principle of an electric potential difference.

Preferably, the energy battery and the power battery have an electric potential difference in a normal state. Preferably, the electric potential of the energy battery is lower than the electric potential of the power battery.

Preferably, an output end of the power battery is connected to a starter motor of a vehicle. The starter motor is connected with a generator. The generator is connected with an engine and peripheral electronic devices. The generator is further connected with a regulator and the regulator is further connected with the energy battery, that is, the electric energy generated by the generator of the vehicle is sent to the energy battery via the regulator for recharging.

### BRIEF DESCRIPTION OF THE DRAWINGS

FIG. 1 is a block diagram of the present invention; and

FIG. 2 is a block diagram of the present invention when implemented.

### DETAILED DESCRIPTION OF THE PREFERRED EMBODIMENTS

Embodiments of the present invention will now be described, by way of example only, with reference to the accompanying drawings.

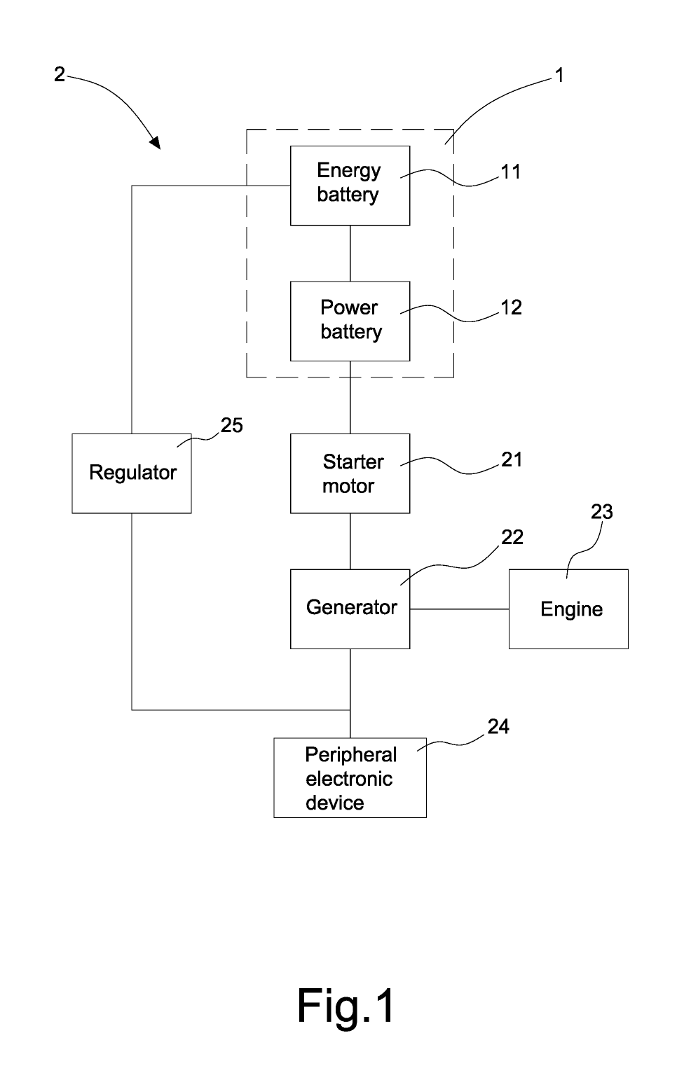

Referring to FIG. 1, the present invention discloses a dual battery device. The dual battery device 1 comprises an energy battery 11 and a power battery 12 which are connected in parallel. Specifically, the dual battery device 1 is a lithium carbon dual battery. Preferably, the energy battery 11 is a lithium structure for storing electric energy. The power battery 12 is a capacitor for charging and discharging instantaneously. Preferably, the power battery 12 is a supercapacitor. The energy battery 11 and the power battery 12 have an electric potential difference in the normal state. Preferably, the electric potential of the energy battery 11 is lower than the electric potential of the power battery 12. An output end of the power battery 12 is connected to a starter motor 21 of a vehicle 2. The starter motor 21 is connected with a generator 22. The generator 22 is connected with an engine 23 and peripheral electronic devices 24. The generator 22 is further connected with a regulator 25. The regulator 25 is further connected with the energy battery 11. That is, the electric energy generated by the generator 22 is sent to the energy battery 11 via the regulator 25 for recharging.

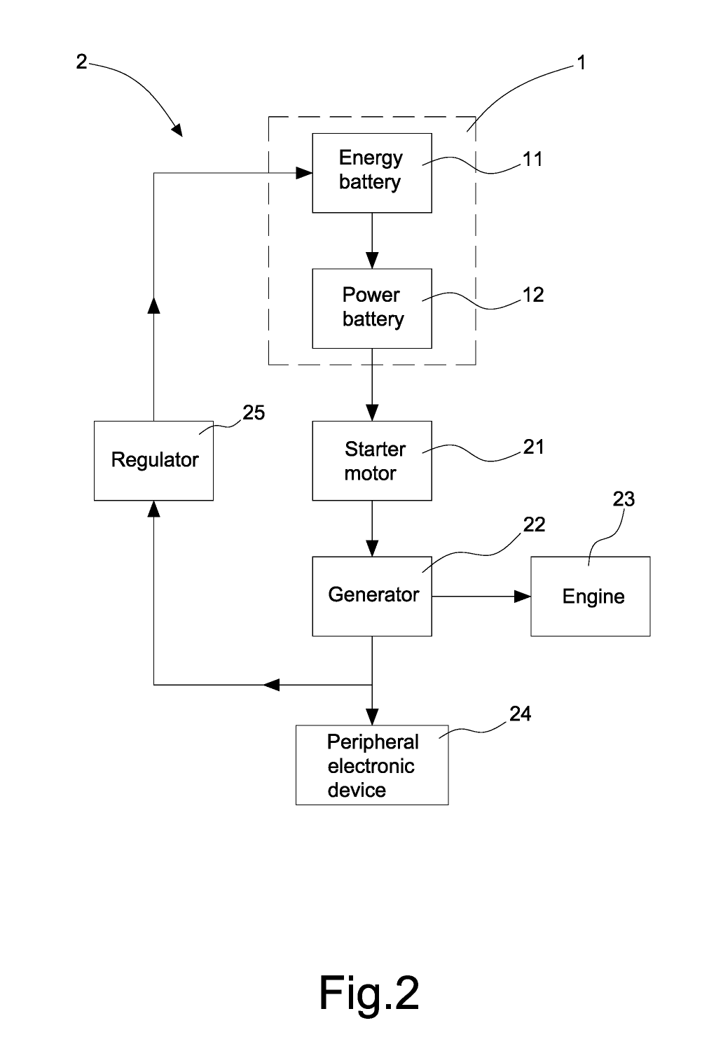

To implement the present invention, as shown in FIG. 2, when the engine 23 is started, the electric energy is rapidly and instantaneously discharged by the power battery 12 to supply the electric energy to the starter motor 21, and the generator 22 starts the engine 23. Meanwhile, the electric potential of the power battery 12 decreases due to instantaneous discharge. At this time, because the electric potential of the energy battery 11 is higher than that of the power battery 12, the electric energy of the energy battery 11 is rapidly transmitted to the power battery 12 until the power battery 12 is full of electric energy for the next use. The electric energy of the energy battery 11 is supplemented through the generator 22.

To implement the present invention, the size of the energy battery 11 and the power battery 12 and the relevant parameters can be calculated by MATLAB (matrix laboratory) and Simulink (design tool). They can be designed by using the electric potential difference and other related principles for supplying current and voltage to a load in order to achieve the best benefits.

The present invention has the following advantages:

1. The dual battery device of the present invention is small in size, and is light in weight, about one-third of a lead-acid battery, a half of a lithium battery.

2. The cost of the dual battery device of the present invention is almost the same as that of a lead-acid battery, but the performance is better than a lead-acid battery. There is no need for an expensive battery management system, so the cost of the dual battery device of the present invention is only a quarter of a lithium battery.

3. The dual battery device of the present invention is made of environmentally friendly materials, with low pollution, low carbon emissions, and low cost.

4. The power battery 12 supplies the required current and voltage to the load, and the energy battery 11 supplies the deficient electricity to the power battery 12 after use. The energy battery and the power battery are complementary so as to prolong the service life effectively.

5. The service life of a traditional lead-acid battery life is about 1 to 2 years; the service life of the dual battery device of the present invention is at least five years.

6. The traditional lead-acid battery needs to be charged at least 2 to 3 months, otherwise it will not be able to produce the reaction; the dual battery device of the present invention is still able to maintain its normal operation if it is not charged at least 8 months.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A dual battery device, comprising:
an energy battery for storing electric energy;
a power battery connected with the energy battery, an output end of the power battery being connected to a load;
wherein after the power battery supplies the electric energy to the load, the energy battery supplements the electric energy to the power battery.

2. The dual battery device as claimed in claim 1, wherein the energy battery is a lithium battery.

3. The dual battery device as claimed in claim 1, wherein the power battery is a capacitor for charging and discharging instantaneously.

4. The dual battery device as claimed in claim 2, wherein the power battery is a capacitor for charging and discharging instantaneously.

5. The dual battery device as claimed in claim 1, wherein the energy battery and the power battery have an electric potential difference in a normal state, and an electric potential of the energy battery is lower than an electric potential of the power battery.

6. The dual battery device as claimed in claim 1, wherein the output end of the power battery is connected to a starter motor of a vehicle, the starter motor is connected with a generator, the generator is connected with an engine; the generator is further connected with a regulator and the regulator is further connected with the energy battery so that the electric energy generated by the generator is sent to the energy battery via the regulator for recharging.
